(19) United States
(12) Patent Application Publication
(10) Pub. No.: US 2015/0309589 A1
(43) Pub. Date: Oct. 29, 2015

(54) ELECTRONIC DEVICE AND ASSOCIATED CONTROL METHOD AND COMPUTER PROGRAM PRODUCT

(71) Applicant: Wistron Corporation, New Taipei City (TW)

(72) Inventor: Chien-Yang Chang, New Taipei City (TW)

(21) Appl. No.: 14/554,077

(22) Filed: Nov. 26, 2014

(30) Foreign Application Priority Data
Apr. 23, 2014 (TW) 103114674

(51) Int. Cl. G06F 3/02; G06F 3/041; G06F 1/16

(52) U.S. Cl. CPC G06F 3/0227; G06F 1/169; G06F 1/1662; G06F 3/0416

(57) ABSTRACT

An electronic device and associated control method and computer program product are provided. The electronic device has a keyboard, a touchpad and a controller. The control method is applied to select an input source of the electronic device. The computer program product stores the control method including steps of: detecting a key input of the keyboard; detecting a touch input of the touchpad; and controlling the electronic device firstly according to the key input.

This application claims the benefit of Taiwan application Serial No. 103114674, filed Apr. 23, 2014, the subject matter of which is incorporated herein by reference.

### BACKGROUND OF THE INVENTION

1. Field of the Invention

The invention relates in general to an electronic device and associated control method and computer program product, and more particularly to an electronic device having a keyboard and a touchpad, and associated control method and computer program product.

2. Description of the Related Art

Based on portable consideration, size of the handheld device is getting smaller and smaller. Taking a notebook computer as an example, a keyboard and a touchpad are provided for a user's operation in a limited space. However, as the notebook computer is getting lighter and thinner, interferences between the keyboard and the touchpad tend to occur when the user operates the notebook computer.

FIG. 1 is a schematic view showing an electronic device uses a keyboard and a touchpad as input sources. In FIG. 1, it is assumed that the electronic device is a notebook computer having a base 10 with a keyboard 11 and a touchpad 13.

It is assumed that a user is performing an editing process. When the user is typing, operation of an operation system (hereinafter, OS) focuses on the keyboard 11. At this time, the OS tends to misdetermine the touchpad 13 as the input of the electronic device if the user inadvertently touches the touchpad 13. For example, the user is originally inputting texts in the third line but the cursor is moved to the tenth line because the user inadvertently touches the touchpad 13. Consequently, the texts subsequently typed by the user will be displayed on the tenth line. That is, when the user uses the keyboard 11 to input texts, an input position tends to be easily affected by the touchpad 13. Consequentially, unexpected errors may generate. Similar problems may also exist in other electronic devices which have both the keyboard and the touchpad.

### SUMMARY OF THE INVENTION

The invention is directed to an electronic device and associated control method and computer program product.

According to a first aspect of the present invention, an electronic device is provided. The electronic device includes a keyboard, a touchpad and a controller. The keyboard detects a key input. The touchpad is disposed on a side of the keyboard and detects a touch input. The controller is electrically connected to the keyboard and the touchpad. When the keyboard and the touchpad are used as input sources of the electronic device, the controller controls the electronic device firstly according to the key input.

According to a second aspect of the present invention, a control method applied to an electronic device having a keyboard and a touchpad is provided. The control method includes steps of: detecting a key input of the keyboard; detecting a touch input of the touchpad; and controlling the electronic device firstly according to the key input.

According to a third aspect of the present invention, a computer program product storing a software program is provided. The software program upon execution enables an electronic device having a keyboard, a touchpad and a controller to execute a control method of selecting an input source. The method includes the steps of: detecting a key input of the keyboard; detecting a touch input of the touchpad; and controlling the electronic device firstly according to the key input.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (prior art) is a schematic view showing an electronic device uses a keyboard and a touchpad as input sources;

FIG. 2 is a system block diagram showing an electronic device according to a first embodiment of the present invention;

FIG. 3 is a flow chart showing a control method according to the first embodiment of the present invention;

FIG. 4 is a system block diagram showing an electronic device according to a second embodiment of the present invention;

FIG. 5 is a flow chart showing a control method according to the second embodiment of the present invention;

FIG. 6 is a system block diagram showing an electronic device according to a third embodiment of the present invention;

FIG. 7 is a schematic view showing a touchpad according to the third embodiment of the present invention;

FIG. 8 is a flow chart showing a control method according to the third embodiment of the present invention; and

FIG. 9 is a schematic view showing a touchpad transferring touch information to an application program.

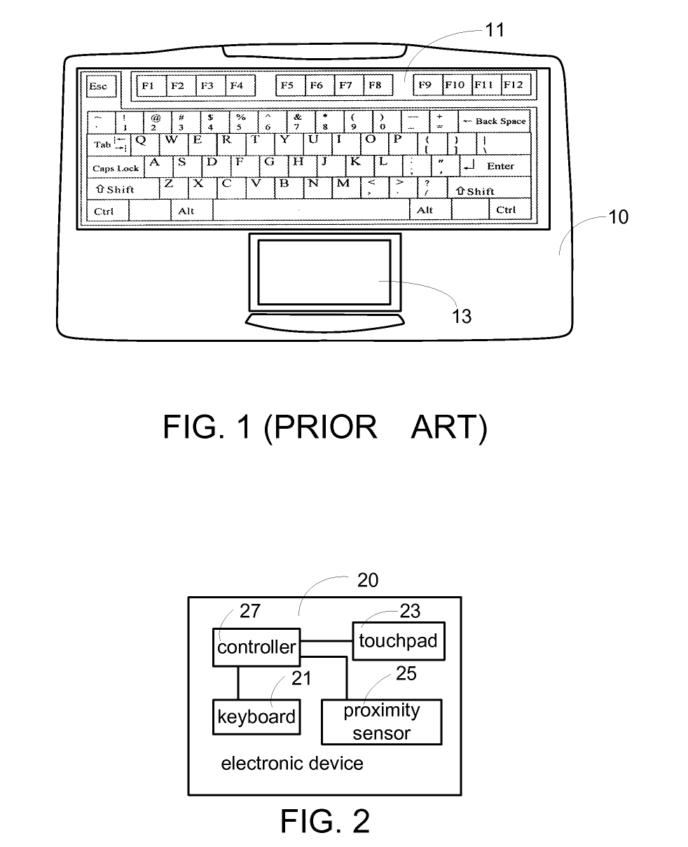

### DETAILED DESCRIPTION OF THE INVENTION

In order to prevent the keyboard and the touchpad from interfering with each other, the present invention provides several embodiments. In the following embodiments, the electronic device firstly uses the keyboard as the input source to prevent the touchpad from interfering with the keyboard.

FIG. 2 is a system block diagram showing an electronic device 20 according to a first embodiment of the present invention. Referring to FIG. 2, the electronic device 20 includes a controller 27, a touchpad 23, a keyboard 21 and a proximity sensor 25. The touchpad 23, the keyboard 21 and the proximity sensor 25 are electrically connected to the controller 27. The proximity sensor 25 senses a relative position and a relative distance between the user and the keyboard 21. The operation principle of the proximity sensor 25 is not particularly restricted.

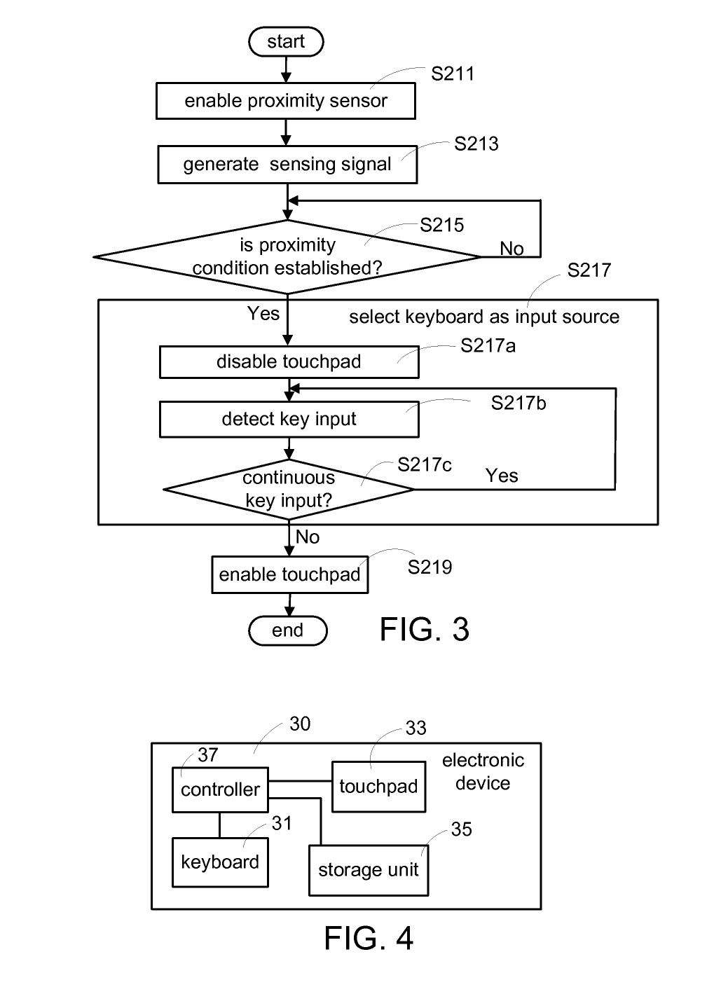

In short, the first embodiment determines whether the user hopes to perform the key input by using the proximity sensor 25. In addition, when the user is performing the key input, the touchpad 23 is disabled. Thus, when the user uses the keyboard 21 to perform the key input, it is ensured that the touchpad 23 cannot interfere with the key input of the keyboard 21. The operation method of each element of this embodiment will be described with reference to FIG. 3.

FIG. 3 is a flow chart showing a control method according to the first embodiment of the present invention. First, the proximity sensor 25 is enabled (step S211). The proximity sensor 25 senses and obtains a sensing signal (step S214). The sensing signal represents a relative position between the users hand (finger) and the keyboard 21. It is assumed that the proximity sensor 25 is mounted at a position near the keyboard 21. When the relative position between the users hand and the keyboard 21 changes, the proximity sensor 25 changes content of the sensing signal correspondingly.

After the sensing signal is transmitted to the controller 27, the controller 27 determines whether a proximity condition is satisfied according to the content of the sensing signal (step S215). When the proximity condition is satisfied, the controller 27 selects the keyboard 21 as the input source (step S217). The proximity condition can represent that the user's hand has touched the keyboard 21; or that a relative distance between the users hand and the keyboard 21 is less than a predetermined threshold distance.

When the controller 27 selects the keyboard 21 as the input source, the controller 27 firstly disables the touchpad (217a). Thereafter, the keyboard 21 continuously detects the key input (step S217b). In addition, the controller 27 determines whether the user continuously uses the keyboard 21 (step S217c).

If the determination result of the step S217c is affirmative, then it represents that the user continuously generates the key input and the key input is still detected. At this time, the controller 27 continuously maintains the setting condition where the electronic device 20 solely enables the keyboard 21, and the touchpad 23 is disabled. If the determination result of the step S217c is negative, then it represents that no more key input is detected by the keyboard 21. Thus, the controller 27 determines that the user has stopped using the keyboard 21, and enables the touchpad 23 (step S219).

Whether the step S217c is satisfied or not can be used in conjunction with a predetermined input period. For example, the predetermined input period of 0.5 seconds represents that if the user has pressed a key on the keyboard 21 without pressing any other key over 0.5 seconds, it is determined that the user has temporarily stopped using the keyboard 21. At this time, the controller 27 enables the touchpad 23 again. Of course, the predetermined input period may also be 1 second or any other value, which is not particularly restricted.

In addition to the use of the proximity sensor 25, the present invention may also adopt another control method to select the input source of the electronic device. The methods in the second and third embodiments are compatible with the architecture of the existing electronic device. That is, the control method of each embodiment may be stored in a computer program product and used in conjunction with the electronic device having the controller, the keyboard and the touchpad.

FIG. 4 is a system block diagram showing an electronic device 30 according to a second embodiment of the present invention. Referring to FIG. 4, the electronic device 30 includes a controller 37, a touchpad 33, a keyboard 31 and a storage unit 35. The controller 37 is electrically connected to the storage unit 35, the touchpad 33 and the keyboard 31.

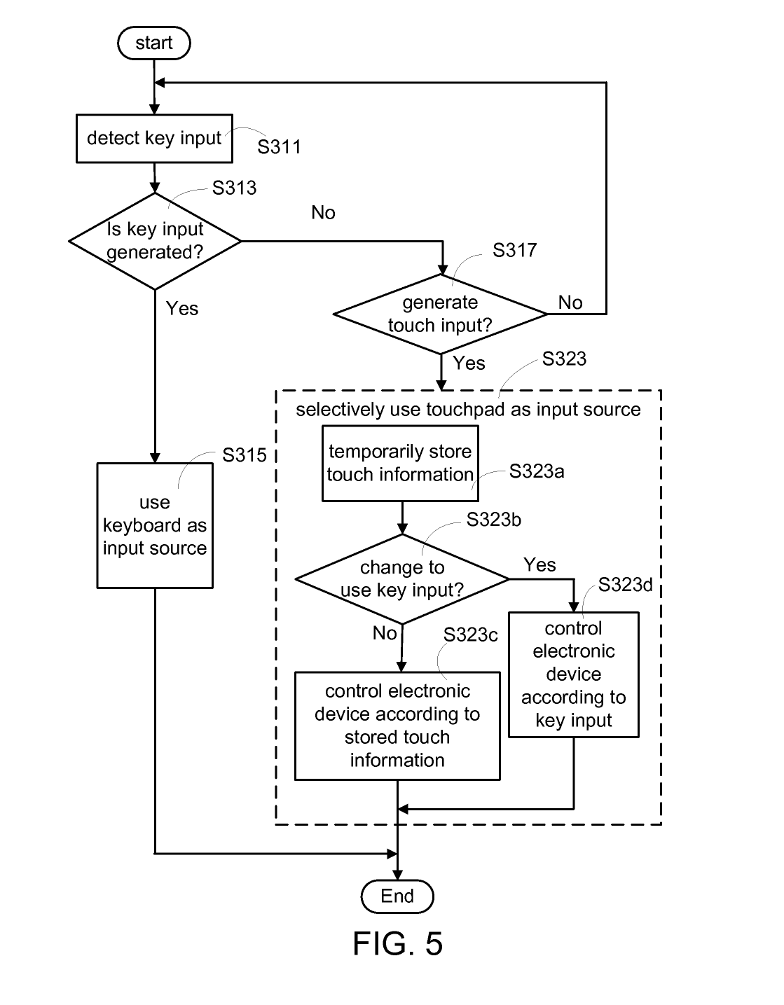

FIG. 5 is a flow chart showing a control method according to the second embodiment of the present invention. Referring to FIG. 5, a key input is firstly detected (step S311), and whether the key input actually generates is determined (step S313). If the determination result of the step S313 is affirmative, the keyboard 31 is used as the input source of the electronic device 30 (step S315). The processes of the step S315 are similar to those of the step S217 of FIG. 3, and detailed descriptions thereof will be omitted.

On the other hand, if the determination result of the step S313 is negative, whether a touch input generates on the touchpad 33 is further determined (step S317). If the determination result of the step S317 is negative, then it represents that there is no input operation. Thus, the procedure goes back to the step S311.

Furthermore, when the determination result of the step S317 is affirmative, the touchpad 33 is selectively used as the input source of the electronic device 30 (step S323). The object of the step S323 is to eliminate the condition where the user inadvertently touches the touchpad 33. When the touchpad 33 provides the touch function, both the coordinate information (x, y) and the motion vector (ΔX, ΔY) information will be generated, where (ΔX, ΔY) ranges from −255 to +255.

When the user intends to use the touchpad 33 to perform the touch operation, continuous motion coordinates and a larger motion vector will be generated on the touchpad 33. The value of the motion vector is usually greater than a predetermined value. For example, the motion vector makes the coordinates of the touch point change from (0, 0) to (10, 10) to (20, 20) to (30, 30). Therefore, in a case that the touch information of the touch input generated by the touchpad 33 represents discontinuous coordinates, and the keyboard 31 still continuously generates the key input, whether the user inadvertently touches the touchpad 33 can be clearly determined. The step S323 may further be divided into several sub-steps.

First, the associated touch information generated by the touchpad 33 is temporarily stored in the storage unit 35 through the controller 37 (step S323a). Thereafter, the controller 37 determines whether the user switches to use the keyboard (step S323b).

If the determination result of the step S323b is affirmative, then the controller 37 determines that the user's previous touch input pertains to the inadvertent touch, and the touch information temporally stored in the storage unit 35 is discarded. In addition, the controller 37 controls the electronic device 30 to use the keyboard 31 as the input source (S323d).

If the determination result of the step S323b is negative, the controller 37 determines that the user indeed wants to use the touch input. At this time, the controller 37 uses the touch information, which is previously and temporarily stored in the storage unit 35, to control the electronic device 30 (step S323c). In this case, the controller 37 continuously receives the touch information generated by the touchpad 33.

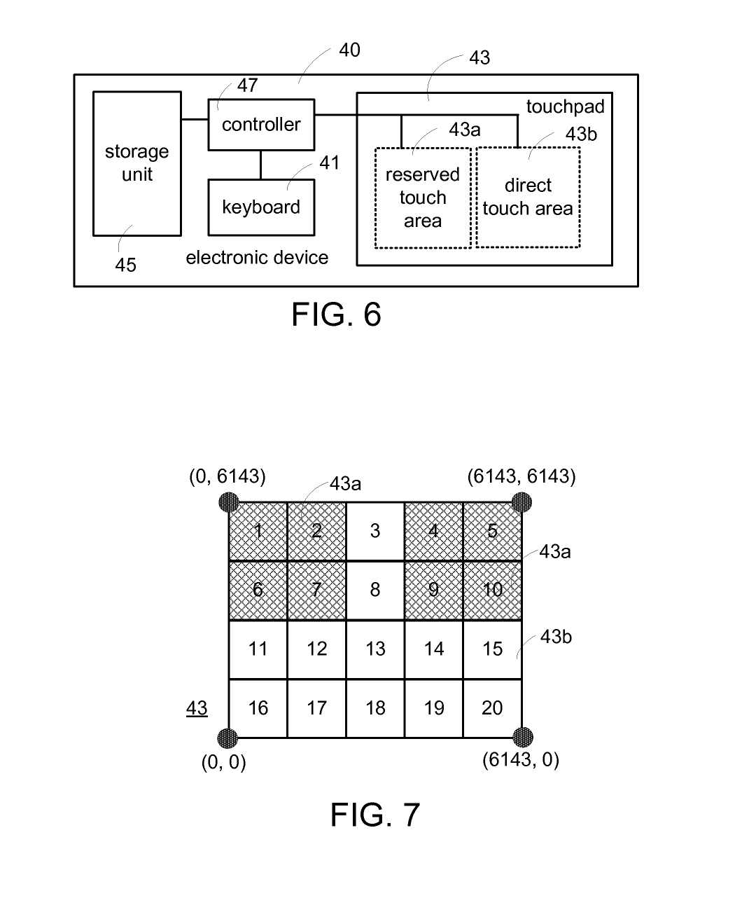

FIG. 6 is a system block diagram showing an electronic device 40 according to a third embodiment of the present invention. Referring to FIG. 6, the electronic device 40 includes a controller 47, a touchpad 43, a keyboard 41 and a storage unit 45. The controller 47 is electrically connected to the storage unit 45, the touchpad 43 and the keyboard 41. The touchpad 43 may further be divided into a reserved touch area 43a and a direct touch area 43b according to physical position.

FIG. 7 is a schematic view showing the touchpad 43 according to the third embodiment of the present invention. Referring to FIG. 7, the reserved touch area 43a is located on one side of the touchpad 43 neighboring the keyboard 41, while the direct touch area 43b is located on one side of the touchpad 43 distant from the keyboard 41. In this drawing, shading represents the reserved touch area 43a. For instance, if the keyboard 41 is disposed above the touchpad 43 in this drawing, then the upper left side of the touchpad 43 (i.e., the areas numbered as 1, 2, 6, 7 in FIG. 7) and the upper right side (i.e., the area numbered as 4, 5, 9, 10 in FIG. 7) are defined as reserved touch areas.

When the user uses the keyboard 41 to perform the key input, the upper left side and the upper right side of the touchpad 43 tend to be inadvertently touched by the side of the user's thumb. As a result, the upper left side and the upper right side of the touchpad 43 pertain to the areas where the inadvertent touch tends to occur relatively. Therefore, the embodiment of the present invention defines the area that tends to be inadvertently touched in the touchpad 43 as the reserved touch area 43a, and defines the area which are not easily inadvertently touched as the direct touch area 43b. The embodiment of the present invention provides different processing methods for the touch inputs generated by the reserved touch area 43a and the direct touch area 43b.

In short, when the touchpad 43 detects the touch input generated by the reserved touch area 43a, the controller 47 waits for a period of time, which is referred to as a reserved input period. In addition, the information regarding the user's touch input generated on the upper left side and the upper right side of the touchpad 43 is also temporarily stored in the storage unit 45.

If the controller 47 confirms that the user indeed wants to use the touchpad 43 to perform the touch input in the reserved input period, the touch information temporarily stored in the storage unit 45 is used for touch control. On the contrary, if the controller 47 still cannot confirm that the user wants to perform the touch input over the reserved input period, the controller 47 discards the touch information in the storage unit 45.

On the other hand, if the touch input is detected as being generated in the direct touch area 43b, the controller 47 assumes that the user indeed wants to use the touchpad 43. Thus, the controller 47 can directly uses the touch information generated by the touchpad 43. In other words, the touch input generated in the direct touch area 43b can be directly used by the controller 47 without being stored in the storage unit 45 in advance. Of course, the position and the range of each of the direct touch area 43b and the reserved touch area 43a can be defined according to different practical applications.

FIG. 7 illustrates the method of defining the position of the touch point on the touchpad. The position of the touch point on the touchpad 43 may be represented by coordinates. For example, if the touch point is located at the lower left corner of the touchpad 43, then it is represented by the coordinates (0, 0). Similarly, if the touch points are located at the lower right corner, the upper left corner and the upper right corner of the touchpad 43, then the coordinates thereof are (6143, 0), (0, 6143) and (6143, 6143), respectively.

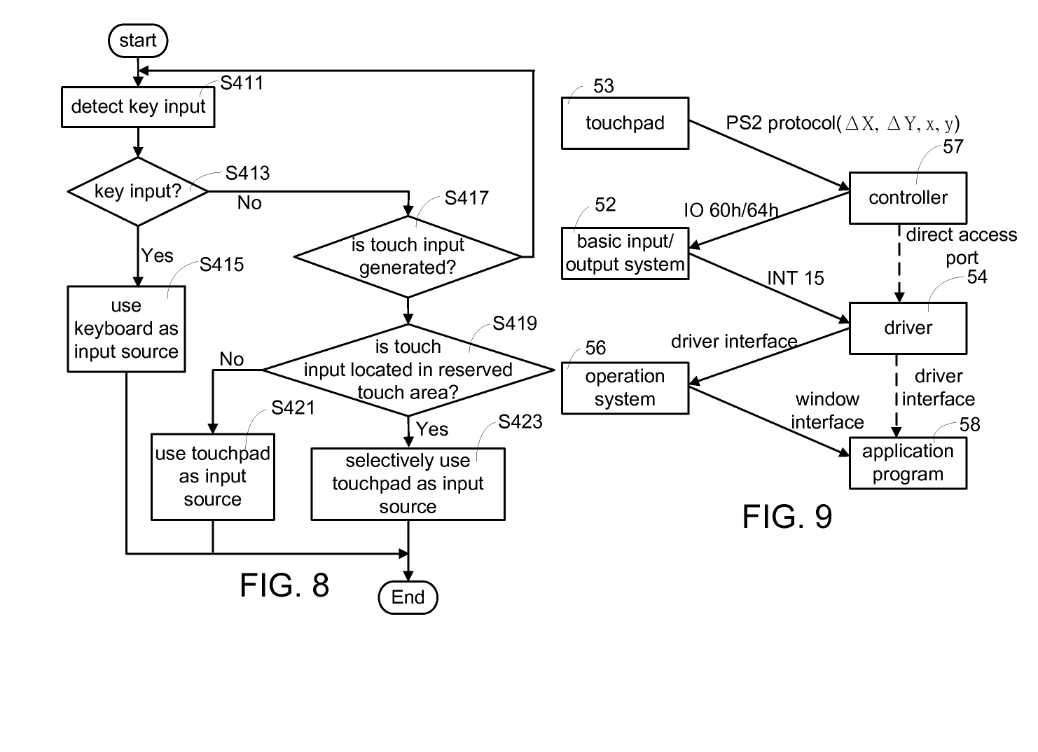

FIG. 8 is a flow chart showing a control method according to the third embodiment of the present invention. First, the key input is detected (step S411), and whether the key input is present is determined (step S413). If the determination result of the step S413 is affirmative, then the keyboard serving as the input source of the electronic device is maintained (step 415). The processes of the step S415 are similar to those of the step S217 of FIG. 3, and detailed descriptions thereof will be omitted.

On the other hand, if the determination result of the step 413 is negative, then it is determined whether the touchpad 43 generates the touch input (step S417). If the determination result of the step S417 is negative, then it represents that there is no input operation. Thus, the procedure returns to the step S411.

Furthermore, when the determination result of the step S417 is affirmative, whether the inadvertent touch occurs will be determined according to the users touch method and touch position on the touchpad 43. As mentioned above, when position of the touch input occurs at the upper left corner or the upper right corner of the touchpad 43, it tends to be caused by the users inadvertent touch. Thus, it is determined whether the touch input is located in the reserved touch area 43a (step S419). If not, it represents that the touch input is located in the direct touch area 43b. The controller 47 determines that the user indeed wants to use the touch function. At this time, the controller 47 uses the touchpad 43 as the input source of the electronic device 40 (step S421).

On the other hand, if the determination result of the step S419 is affirmative, then this condition tends to be caused by the inadvertent touch. At this time, the controller 47 must confirm the input source the user wants to use according to other factors, such as whether the touch information is generated continuously. Therefore, the controller 47 selectively uses the touchpad 43 as the input source (step S423).

In the embodiment of the present invention, the controller 47 may be a keyboard controller (KBC). The touchpad 43 can transfer PS2 packets through the keyboard controller. The keyboard controller can intercept the touch coordinates and the motion vectors generated by the touchpad 43. When the keyboard controller firstly intercepts the discontinuous coordinates and the small motion vectors located in the areas numbered as 1, 2, 4, 5, 6, 7, 9, 10 in FIG. 7, the keyboard controller can temporarily hold the PS2 packets in the storage unit 45 for a period of time (reserved input period). For example, the reserved input period may be 2 seconds.

Thereafter, the keyboard controller further determines whether to delete the PS2 packet transferred from the touchpad 43 according to whether the user performs typing. When the keyboard 41 is continuously in the typing condition, the keyboard controller deletes the PS2 packet transferred from the touchpad 43. Otherwise, the keyboard controller can control the keyboard 41 to continuously perform the keyboard scan. Therefore, the present invention can use the keyboard controller to selectively disable the touchpad and switch the input source of the electronic device. Thus, the inadvertent touch problem of the electronic device 40 can be prevented.

FIG. 9 is a schematic view showing a touchpad 53 transferring the touch information to an application program. The touchpad 53 transfers the touch information (ΔX, ΔY, x, y) to a controller 57 through the PS2 protocol. Thereafter, the controller 57 transfers the touch information to an upper application program 58 (e.g., Word, Paint, or the like), so that the application program 58 operates according to the touch information. It is to be noted that the controller 57 transfers the touch information in a way which is not particularly restricted. For example, in FIG. 9, the dashed line arrow outputted from the controller 57 represents a direct path when the touch information is directly transferred. Alternatively, in FIG. 9, the solid line arrow outputted from the controller represents an indirect path when the touch information is indirectly transferred.

When the touch information is directly transferred, the touch information is transferred to a driver 54 through a direct access port of the controller. Thereafter, the touch information is directly transferred to an application program through a touchpad interface of the driver 54.

When the electronic device provides more functions and contains more function elements, the touch information is usually indirectly transferred. The basic input/output system (BIOS) 52 firstly receives the input code (for example, 60h/64h) from the controller 57. The input code (60h/64h) represents the condition that the touchpad 53 has outputted the touch information. At this time, the BIOS 52 generates an interrupt vector (for example, interrupt vector 15) to the driver 54. Next, the driver 54 transfers the touch information to the OS 56 through the driver interface. The OS 56 again transfers the touch information to the application program through the window interface.

When the touch information is actually transferred to the application program 58, the format and information content have been respectively processed and converted by the BIOS 52, the driver 54 and the OS 56. Alternatively, the BIOS 52, the driver 54 and the OS 56 add control interfaces and the like associated with the touch input while transferring the touch information. The variation of the transfer format and the actual content of the touch information between the BIOS 52, the driver 54 and the OS 56 do not affect the method of the present invention, and detailed descriptions thereof will be omitted.

It is to be noted that the direct transfer and the indirect transfer of the touch information should be adjusted according to the layout of the system program in the electronic device. Thus, processes of the solid line and the dashed line arrows of FIG. 9 may be alternated. For example, if the function of the electronic device is relatively simple and the OS 56 is not used, then the driver 54 can directly transfer the touch information to the application program 58 after receiving the interrupt vector (for example, 15) from the BIOS 52. In other words, the method and the path of transferring the touch information do not affect the control method of the present invention of selecting either the keyboard of the touchpad as the input source.

As mentioned above, the embodiments of the present invention provide the function of firstly detecting the key input in the electronic device, and provide several methods of preventing the user from inadvertently touching the touchpad. For example, the proximity sensor is used to determine whether the user's hand approaches the keyboard; the touchpad is disabled when the key input is performed, and then automatically enabled after the key input ends; and when the touchpad generates the touch input, the touch information (coordinates, motion vectors and the like) is temporarily stored in the storage unit, and the touch information is selectively reserved or deleted according to whether following touch input is performed. These control methods can be used solely or in conjunction with each other or one another. The present invention can prevent the inadvertent touch and effectively switch the input source without causing inconvenience in use.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device, comprising:
a keyboard, for detecting a key input;
a touchpad, disposed on a side of the keyboard, for detecting a touch input; and
a controller, electrically connected to the keyboard and the touchpad, wherein when the keyboard and the touchpad are used as input sources of the electronic device, the controller controls the electronic device firstly according to the key input.

2. The electronic device according to claim 1, further comprising:
a proximity sensor, electrically connected to the controller, for generating a sensing signal, wherein the controller selectively disables the touchpad according to the sensing signal.

3. The electronic device according to claim 2, wherein the controller disables the touchpad when a proximity condition is satisfied, and the proximity condition represents that:
a user touches the keyboard; or
a distance between the user and the keyboard is less than a predetermined threshold distance.

4. The electronic device according to claim 1, wherein when the key input is generated before the touch input, the controller disables the touchpad.

5. The electronic device according to claim 4, wherein when the key input stops and after a predetermined input period, the controller enables the touchpad.

6. The electronic device according to claim 1, wherein when the key input is generated after the touch input, the controller selectively controls the electronic device according to the touch input, and continuously detects the key input using the keyboard.

7. The electronic device according to claim 6, wherein the touchpad comprises:
a reserved touch area, disposed on one side of the touchpad neighboring the keyboard, wherein when the touch input is located in the reserved touch area, the controller selectively uses the touchpad as the input source of the electronic device; and
a direct touch area, disposed on one side of the touchpad distant from the keyboard, wherein when the touch input is located in the direct touch area, the controller uses the touchpad as the input source of the electronic device.

8. The electronic device according to claim 7, wherein
when the touch input is located in the reserved touch area and the key input is not generated within a reserved input period, the controller controls the electronic device according to touch information of the touch input; or
when the touch input is located in the reserved touch area and the key input is generated within the reserved input period, the controller controls the electronic device according to the key input.

9. The electronic device according to claim 6, further comprising:
a storage unit, electrically connected to the touchpad and the controller, wherein
the touch information is temporarily stored in the storage unit, and the controller selectively uses the touch information.

10. The electronic device according to claim 9, wherein
when the key input is not generated within a reserved input period, the controller controls the electronic device according to the touch information in the storage unit; or
when the key input is generated within the reserved input period, the controller controls the electronic device according to the key input.

11. The electronic device according to claim 1, wherein the controller transfers touch information of the touch input to an application program, and the application program operates in response to the touch information.

12. The electronic device according to claim 11, wherein after the controller transfers the touch information to a basic input/output system, the touch information is transferred to the application program through a driver and an operation system.

13. A control method applied to an electronic device having a keyboard and a touchpad, the control method comprising the steps of:
detecting a key input of the keyboard;
detecting a touch input of the touchpad; and
controlling the electronic device firstly according to the key input.

14. The control method according to claim 13, further comprising the steps of:
generating a sensing signal; and
selectively disabling the touchpad according to the sensing signal.

15. The control method according to claim 14, wherein the step of selectively disabling the touchpad according to the sensing signal represents: disabling the touchpad when a proximity condition is satisfied.

16. The control method according to claim 15, wherein the proximity condition represents that:
a user touches the keyboard; or
a distance between the user and the keyboard is less than a predetermined threshold distance.

17. The control method according to claim 13, wherein when the key input is generated before the touch input, the step of controlling the electronic device firstly according to the key input comprises steps of:
disabling the touchpad; and
enabling the touchpad when the key input stops and after a predetermined input period.

18. The control method according to claim 13, wherein when the key input is generated after the touch input, the step of controlling the electronic device firstly according to the key input comprises steps of:
selectively controlling the electronic device according to the touch input; and
continuously using the keyboard to detect the key input.

19. The control method according to claim 18, wherein the touchpad comprises a reserved touch area and a direct touch area, and the step of selectively controlling the electronic device according to the touch input comprises steps of:
controlling the electronic device according to touch information of the touch input when the touch input is located in the reserved touch area and the key input is not generated within a reserved input period;
controlling the electronic device according to the key input when the touch input is located in the reserved touch area and the key input is generated within the reserved input period; and
using the touchpad as an input source of the electronic device when the touch input is located in the direct touch area.

20. The control method according to claim 18, further comprising the steps of:
temporarily storing touch information of the touch input;
controlling the electronic device according to the temporarily stored touch information when the key input is not generated within a reserved input period; and
controlling the electronic device according to the key input when the key input is generated within the reserved input period.

21. The control method according to claim 13, further comprising the step of:
transferring touch information to an application program.

22. A computer program product storing a software program, which upon execution enables an electronic device having a keyboard, a touchpad and a controller to execute a control method of selecting an input source, comprising steps of:
detecting a key input of the keyboard;
detecting a touch input of the touchpad; and
controlling the electronic device firstly according to the key input.
